(19) United States
(12) Patent Application Publication
(10) Pub. No.: US 2017/0191299 A1
(43) Pub. Date: Jul. 6, 2017

(54) REMOTE CONTROL WINDOW SYSTEM

(71) Applicant: Guru Hariprasad, Jamaica, NY (US)

(72) Inventor: Guru Hariprasad, Jamaica, NY (US)

(21) Appl. No.: 15/374,826

(22) Filed: Dec. 9, 2016

Related U.S. Application Data
(60) Provisional application No. 62/266,228, filed on Dec. 11, 2015.

(51) Int. Cl. E05F 15/60; E06B 3/44

(52) U.S. Cl. CPC E05F 15/60; E06B 3/4415; E05Y 2900/55; E05F 2700/00

(57) ABSTRACT

A remote control window system for opening and closing windows is provided. The window have at least one movable window sash. The remote control window system comprises a drive mechanism for driving the at least one movable window sash in a generally alternatingly upward and downward direction. A motor is electrically connected to the drive mechanism and an activation switch activates the drive mechanism. Upon activating the drive mechanism, the motorized drive mechanism alternatingly raises and lowers the at least one movable window sash in an effective and efficient manner in residential, commercial and institutional settings.

### CLAIM OF PRIORITY

This patent application claims priority under 35 USC 119 (e) (1) from U.S. Provisional Patent Application Ser. No. 62/266,228 filed Dec. 12, 2015, of common inventorship herewith entitled, “Power Windows,” which is incorporated herein by reference as though the same were set forth in its entirety.

### FIELD OF THE INVENTION

The present invention pertains to the field of building supplies, and more specifically to the field of powered windows.

### BACKGROUND OF THE INVENTION

The word window comes to us from Scandinavians who invaded and settled in England during early Middle Ages. A compound word that combines the words vindr for wind and auga for eye, the Norse derived words wind-eye, which became the English word window, reflecting a fact that, for much of human history, windows contained no glass. Windows let in light and gave their owners a view of the outside world, but they were simply openings in walls, eyes through which the wind blew.

Today, we speak of windows with words less poetic than wind-eye but in each case, a window is seen as an opening, a portal through which something passes, as light passes through clear glass. A cable news network claims to be our window on the world. We check our calendars to see whether we have a window of opportunity to do something on a given day. Lovers claim that the eyes of their beloved are windows on the soul. We open and close windows on our computer screens, gaining views of work, play, and information. NASA officials postpone rocket launches until decent weather arrives, seeking a launch window that allows a given trajectory. When some possibility for us vanishes, we might dismiss it as it went or flew out the window. Each of these expressions is a metaphor, but the fact there are so many window metaphors suggests an importance of windows in our lives.

Glass windows let in the light of the world, affording us a view while protecting us from the extremes of temperature and humidity. Windows break up our wall space and provide a view of a genuine world, with all its changing light and color and movement. Fascinating in their history and essential to our lives, windows let outside air in or keep it out. A physical act of opening and closing windows, which most of us take for granted, is impossible for those individuals disabled by age, illness or injury and sometimes a pain for the rest of us.

The prior art has put forth several designs for powered windows. Among these are:

US Patent 2007/0277442 to Sabin Dery, Rejeap Daoust and Gino Grondin describes a motorized inline sliding window structure. The sliding window structure comprises a window frame having upper and lower slide rails. A fixed glass is provided in the frame and a displaceable window panel. Guide channels are provided in the slide rails to guide the displaceable window panel from a closed position, where the displaceable panel is disposed in a substantially common plane with the fixed glass, to an offset open position, where the displaceable window panel is retracted out of the common plane and displaced along the guide channels in the slide rails to a desired position behind the fixed window panel. An electric motor is connected to flexible cables to displace the displaceable window panel along the guide channels. The flexible cables and their connectors are displaceable in a concealed routed channel associated with a guide channel of said slide rails.

U.S. Pat. No. 5,782,036 to Fiorenza Bertieri and Richard L. Miller describes a disabled person's multiple appliance and window remote control system that allows a disabled person to remotely and automatically operate appliances and windows by merely aiming a remote control at an appliance and a window. The system includes a programmable infrared remote control and a separate and local control system. The programmable infrared remote control has an infrared transmitter that generates separate infrared signals associated with an appliance and a window. The separate and local control system is associated and in electrical communication with appliances and windows and receives the infrared signal from the programmable infrared remote control, so that the disabled person can remotely and automatically operate appliances and windows by merely aiming the programmable infrared remote control at any the separate and local control system associated with the appliance and the window regardless of which one of the at least one of the at least one appliance and the at least one window the disabled person desires to operate.

U.S. Pat. No. 2,606,607 to Lawrence Vita describes a window having a movable heavy pane of glass. A metal netting supports the glass by its upper edge. A roller on which the netting winds to lift the glass. A motor is adapted to turn the roller. An electric circuit drives the motor and switches for the circuit. The combination of operating arms open the switches at the limits of travel of the glass and a shaft geared to the roller carries the arms.

None of these prior art references describe the present invention.

### SUMMARY OF THE INVENTION

It is an object of the present invention to provide an easy, effective and efficient system for opening and closing windows in residential, commercial, and institutional settings.

The present invention is a remote control window system for opening and closing windows. The window have at least one movable window sash. The remote control window system comprises a drive mechanism for driving the at least one movable window sash in a generally alternatingly upward and downward direction. A motor is electrically connected to the drive mechanism and an activation switch activates the drive mechanism. Upon activating the drive mechanism, the motorized drive mechanism alternatingly raises and lowers the at least one movable window sash in an effective and efficient manner in residential, commercial and institutional settings.

In addition, the present invention includes a method for opening and closing windows, the window having at least one movable window sash. The method comprises providing a drive mechanism, electrically connecting a motor to the drive mechanism, activating the drive mechanism, and driving the at least one movable window sash in a generally alternatingly upward and downward direction.

### BRIEF DESCRIPTION OF THE DRAWINGS

FIG. 1 is a perspective view illustrating a remote control window system, constructed in accordance with the present invention, with the windows in a closed position.

FIG. 2 is a perspective view illustrating the remote control window system, constructed in accordance with the present invention, with the windows in an open position.

FIG. 3 is a perspective view illustrating a remote control unit of the remote control window system, constructed in accordance with the present invention, showing arched oval shaped push buttons for opening and closing the windows.

FIG. 4 is a perspective view illustrating a cell phone application for use with the remote control window system, constructed in accordance with the present invention, showing blue rectangular shaped icons for opening and closing the windows.

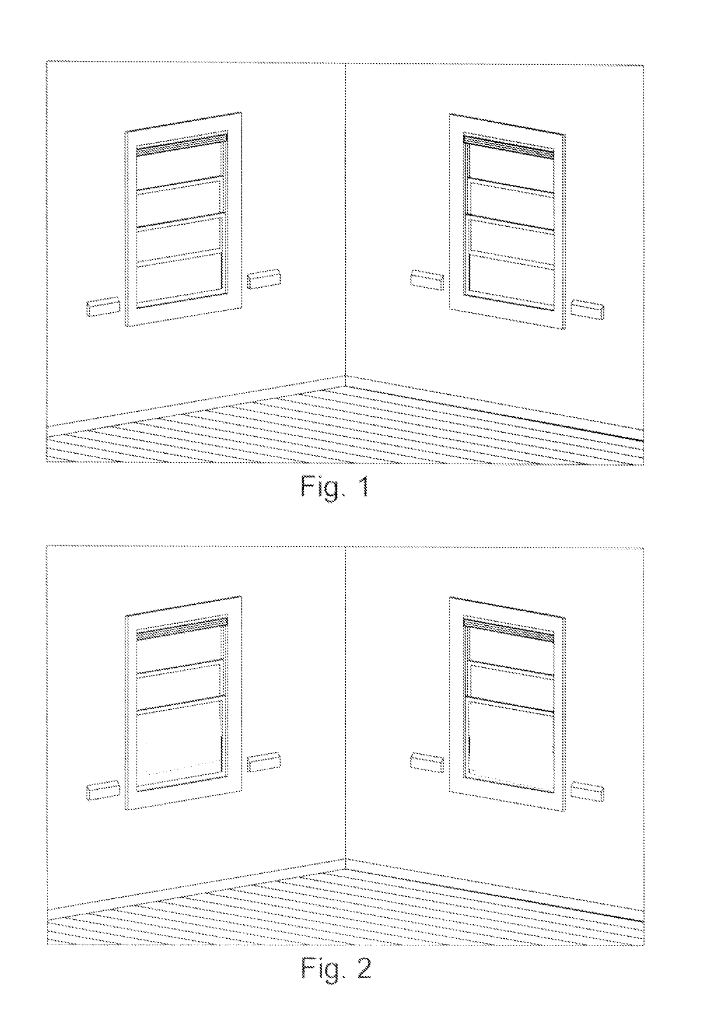

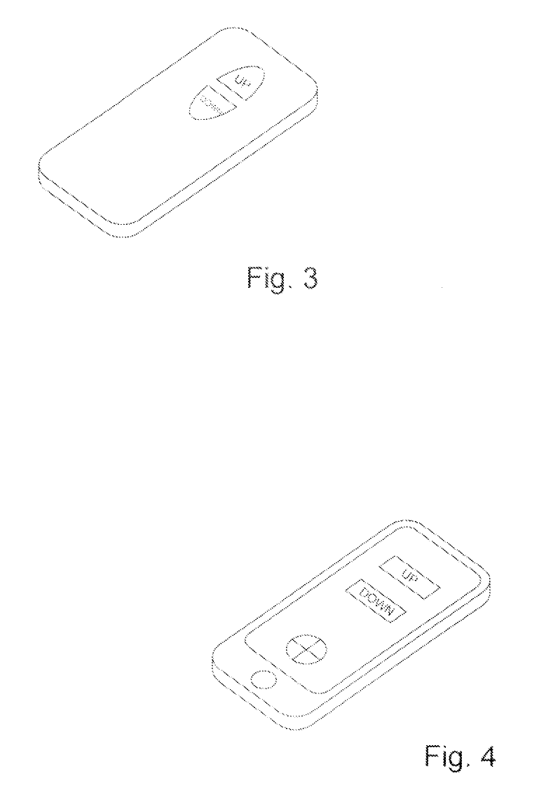

### DETAILED DESCRIPTION OF THE INVENTION

The present invention, hereinafter referred to as a Remote

Control Window System, indicated generally at 10, is a motorized, remote controlled or wall switch controlled window 12, suitable for installation in residential and commercial buildings. The Remote Control Window System 10 provides individuals, especially those whose age or physical condition makes it difficult to raise or lower windows 12 in the traditional manual fashion, with an easier and convenient way of opening and closing windows 12. The Remote Control Window System 10 provides users with an easy, effective and efficient system for opening and closing windows 12 in residential, commercial and institutional settings.

The Remote Control Window System 10 of the present invention equips a variety of windows 12 with a motorized, remote controlled mechanism 14 for opening and closing the window 12 at the push of a button 16 on the remote control 14, relieving users of a need to reach and strain to get the window 12 opened or closed. The Remote Control Window System 10 is produced for use with a wide variety of window types including single hung and double hung sash windows, casement windows, horizontally sliding windows, awning style windows, and jalousie or louvered windows. The technical details of the motorized raising-and lowering or opening-and-closing mechanism vary according to the type of window 12 being offered or retrofitted.

The following descriptions pertain to Remote Control Window System 10 of the present invention being installed in a standard double hung sash window 12 measuring approximately forty (40″) inches in height by twenty two (22″) inches in width and fabricated in vinyl or aluminum. In a preferred embodiment of the drive mechanism for the present invention, the right and left sides of the upper and lower window sashes are tracked and raised or lowered by a recessed motor that raises or lowers each half of the window by means of a chain or pulley system. In another embodiment for the drive mechanism is to equip the sides of the sashes with toothed tracks which are raised or lowered by a rotation of approximately four cogwheels positioned on each side of the window. Two cogwheels reside on the upper sash and two cogwheels reside on the lower sash. The motor 18 is electrically powered and concealed behind the drywall adjacent to the window 12 or positioned on each side of the window 12, The motor 18 is wired into the house or building's electrical system and controlled by a handheld. Radio Frequency or RF remote control bearing an Up and Down toggle button for the upper sash and the lower sash.

Windows 12 are often hard to reach, requiring that individuals stand or kneel on couches or beds, lean and reach over tables and desks, and similarly contort themselves just to reach windows 12 and then strain their bodies in an effort to get the window 12 opened or closed. This inaccessibility factor is an inconvenience and an annoyance to anyone, but when the individual in question is elderly or disabled, the opening and closing of windows 12 becomes a practical impossibility. Because the Remote Control Window System 10 of the present invention operates so quickly and easily, the system is highly functional and efficient for such settings as nursing homes and assisted living facilities, where the healthcare staff employ the system on their rounds to immediately accommodate a patient or resident's wishes. Durably constructed of high quality materials, the Remote Control Window System 10 will withstand many years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A remote control window system for opening and dosing windows, the window having at least one movable window sash, the remote control window system comprising:
a drive mechanism for driving the at least one movable window sash in a generally alternatingly upward and downward direction;
a motor electrically connected to the drive mechanism; and
an activation switch for activating the drive mechanism;
wherein upon activating the drive mechanism, the motorized drive mechanism alternatingly raises and lowers the at least one movable window sash in an effective and efficient manner in residential, commercial and institutional settings.

2. The remote control window system of claim I wherein the windows are selected from the group consisting of single hung and double hung sash windows, casement windows, horizontally sliding windows, awning style windows, and jalousie or louvered windows.

3. The remote control window system of claim 1 wherein the drive mechanism is a chain and pulley system.

4. The remote control window system of claim 1 wherein the drive system is toothed tracks raised or lowered by a rotation of a plurality of cogwheels.

5. The remote control window system of claim 4 and further comprising:
four cogwheels positioned on each side of the window with two cogwheels residing on an upper sash and two cogwheels residing on a lower sash.

6. The remote control window system of claim 1 wherein the motor is recessed motor behind drywall adjacent the window. The remote control window system of claim 1 wherein the motor is positioned on each side of the window.

8. The remote control window system of claim 1 wherein the motor is wired into a house or building's electrical system.

9. The remote control window system of claim 1 wherein the activation switch is a hand-held, RF remote control mechanism having an open button and a close button.

10. The remote control window system of claim 1 wherein the activation switch is a cell phone application programmed on a cell phone.

11. The remote control window system of claim 1 wherein the activation switch is wall mounted.

12. A method for opening and closing windows, the window having at least one movable window sash, the method comprising:
providing a drive mechanism;
electrically connecting a motor to the drive mechanism;
activating the drive mechanism; and
driving the at least one movable window sash in a generally alternatingly upward and downward direction.

13. The method of claim 12 wherein the drive mechanism is a chain and pulley system.

14. The method of claim 12 wherein the drive system is toothed tracks raised or lowered by a rotation of a plurality of cogwheels.

15. The method of claim 14 and further comprising:
positioning four cogwheels on each side of the window with two cogwheels residing on an upper sash and two cogwheels residing on a lower sash.

16. The method of claim 12 and further comprising:
recessing the motor behind drywall adjacent the window.

17. The method of claim 12 and further comprising:
positioning the motor on each side of the window.

18. The method of claim 1 and further comprising:
wiring the motor into a house or building's electrical system.

19. The method of claim 12 wherein the activation switch is a hand-held, RF remote control mechanism having an open button and a close button.

20. The method of claim 12 wherein the activation switch is a cell phone application programmed on a cell phone.
